(19) United States
(12) Patent Application Publication
(10) Pub. No.: US 2012/0134376 A1
(43) Pub. Date: May 31, 2012

(54) Radiation-Insensitive Optical Fiber Doped with Rare Earths

(75) Inventors: Ekaterina Burov, Boulogne-Billancourt (FR); Gilles Melin, Orsay (FR); Alain Pastouret, Massy (FR); David Boivin, Longjumeau (FR)

(73) Assignee: DRAKA COMTEQ, B.V., Amsterdam (NL)

(21) Appl. No.: 13/303,967

(22) Filed: Nov. 23, 2011

(30) Foreign Application Priority Data
Nov. 25, 2010 (FR) 10/59719

(51) Int. Cl. H01S 3/02; B05D 5/06; H05H 1/24; G02B 6/02; H01S 3/067; B82Y 20/00

(52) U.S. Cl. 372/6; 385/123; 359/341.3; 427/162; 427/578; 977/932

(57) ABSTRACT

An optical fiber includes a central core for transmitting and amplifying an optical signal, an optical cladding to confine the optical signal transmitted by the central core, and an outer cladding. The central core is formed of a core matrix and nanoparticles. The nanoparticles are formed of a nanoparticle matrix and rare earth dopants (i.e., a nanoparticle matrix surrounding the rare earth dopants). The optical cladding has a plurality of holes separated by a pitch and extending along the length of the optical fiber.

### CROSS REFERENCE TO PRIORITY APPLICATION

This application hereby claims the benefit of pending French application Ser. No. 10/59719 for a “Fibre Optique Dopee en Terres Rares Insensible aux Irradiations” (filed Nov. 25, 2010 at the National Institute of Industrial Property (France)), which is hereby incorporated by reference in its entirety.

### FIELD OF THE INVENTION

The present invention relates to the field of optical fibers and, more specifically, to a radiation-insensitive optical fiber that is doped with rare earths (e.g., rare-earth ions). The present invention also relates to a method of fabricating such an optical fiber.

### BACKGROUND

An optical fiber (i.e., a glass fiber typically surrounded by one or more coating layers) conventionally includes an optical fiber core, which transmits and/or amplifies an optical signal, and an optical cladding, which confines the optical signal within the core (i.e., the central core). Accordingly, the refractive index of the core n_{c} is typically greater than the refractive index of the optical cladding n_{g} (i.e., n_{c}>n_{g}). The refractive index difference between the central core and the cladding is typically obtained by introducing dopants into the central core and/or the cladding.

The central core and the optical cladding are typically obtained by vapor deposition, such as modified chemical vapor deposition (MCVD), outside vapor deposition (OVD), vapor axial deposition (VAD), etc. In a typical MCVD process, the outer cladding is formed of the deposition tube and possibly by overcladding or sleeving. Generally speaking, elements of low volatility such as aluminum or elements from the rare earths group (referred to below as “rare earths,” “rare earth dopants,” “rare earth ions,” or “rare-earth-dopant elements”) are incorporated by impregnating a porous layer of silica (SiO₂), which, for example, might be obtained during an intermediate step of the MCVD process. Rare earths are impregnated into a deposit using a solution containing rare earths. Such a solution might be obtained from dissolved salts, for example.

Systems employing amplification of the optical signal routinely use optical fibers doped with rare earths. For example, optical fibers doped with erbium are used in erbium-doped fiber amplifiers (EDFAs) to amplify the optical signal transmitted in some long-haul optical telecommunications systems. EDFAs offer high performance in terms of power consumption and optical power conversion efficiency. Optical fibers doped with rare earths typically have a central core formed of a silica matrix containing rare earths, such as erbium at weight concentrations on the order of 250 parts per million (ppm) to 1000 ppm (i.e., 0.025 weight percent to 0.1 weight percent (wt %)).

The gain of an amplifying optical fiber is a function of the wavelength of the incident signal. For example, an optical fiber doped with erbium may be used in the C-band (1530 nanometers-1565 nanometers). An optical fiber doped with erbium conventionally has a gain width of approximately 30 nanometers to 35 nanometers in the C-band and a numerical aperture of 0.23. Furthermore, when other types of rare earth elements (i.e., rare earth ions) are used, different wavelength ranges may be used.

Wavelength-division multiplex (WDM) applications require high gain width. To this end, rare earths may be associated with complementary dopants that improve amplification. The complementary dopants improve amplification by preventing interaction between the rare earths. To this end, the complementary dopants must surround the rare earths. When doping the optical fiber using a solution containing rare earths, the concentration of complementary dopants is very high in order for each rare earth in the central core to be surrounded by complementary dopants. Aluminum (Al) is one example of a complementary dopant (e.g., in the form of aluminum oxide).

Moreover, in applications in environments exposed to radiation, such as in nuclear power stations, optical systems have several advantages over electronic systems. Optical fibers have better electromagnetic immunity and better chemical stability. Optical fibers make it possible to obtain more reliable and safe communications systems that require little maintenance. Optical fibers also make it possible to obtain a high data rate. Optical fibers are also very compact, which makes them particularly suitable for uses in systems on-board aircraft and spacecraft.

That said, environments exposed to radiation tend to increase an optical fiber's background losses, and thus increase attenuation of the transmitted signal. This increase in background losses may be caused by defects in the structure of the silica created by radiation. Such defects include, for example, dangling bonds and trapped charges that absorb the optical signal transmitted in the optical fiber at certain wavelengths.

The increase in background losses may also be caused by the creation of specific defects linked to the dopants that are necessary to obtain the properties of optical-signal guidance. The importance of dopants to the radiation sensitivity of the optical fiber is explained with reference to FIG. 1.

FIG. 1 provides attenuation values for a transmitted signal in various exemplary optical fibers. The ordinate axis shows the radiation-induced attenuation (RIA) expressed in decibels per kilometer per gray (dB/km/Gy) and is normalized to the radiation dose. The abscissa axis shows the wavelength of the transmitted signal expressed in nanometers. Curve 1 was acquired for an optical fiber with a pure silica core (i.e., having no dopants in the core) irradiated at 100 grays (Gy). Curve 2 was acquired from an optical fiber doped with aluminum at a concentration of approximately 7 weight percent in the central core irradiated at 360 Gy. Curve 3 was acquired from an optical fiber doped with phosphorus at a concentration of 10 weight percent in the central core irradiated at 500 Gy. Curve 4 was acquired from an optical fiber doped with germanium at a concentration of approximately 5 weight percent in the central core irradiated at 100 Gy.

The radiation-induced attenuation depends on the wavelength of the transmitted signal and on the radiation-sensitive dopants present in the optical fiber's central core. Thus, the increase in the attenuation of the optical signal in an EDFA depends on the dopants (e.g., germanium, aluminum, phosphorus, or fluorine) that are used to obtain predetermined guidance properties. The increase in signal attenuation also depends on elements introduced because of the fabrication process. For example, chlorine is used to prevent contamination of the materials by hydroxide ions (OH⁻). The increase in attenuation further depends on the complementary dopants used to obtain the required amplification properties. Exemplary complementary dopants include aluminum, phosphorus, antimony, lanthanum, and bismuth.

To reduce the sensitivity of an optical fiber to radiation, a publication by Regnier et al. entitled “Recent developments in optical fibers and how defense, security and sensing can benefit,” Proceedings of the SPIE, Vol. 7306, 730618 (2009) proposes eliminating the complementary dopants required for the amplification properties by instead employing rare earth doping using silica nanoparticles. The nanoparticles are made of a matrix of silica and rare earths. The chemical composition of the nanoparticles ensures that the rare earths do not form aggregates. Because the matrix contains no complementary dopants, sensitivity to radiation is reduced. Complementary dopants, however, improve the quality of amplification. Eliminating the complementary dopants precludes high spectral bandwidth applications such as WDM. Furthermore, silica has limited solubility for rare earths, which limits amplification gain. Thus, for doping with erbium, using silica nanoparticles is limited to optical fibers having a weight concentration of erbium of less than 300 ppm.

Other solutions propose reducing the length of the optical fiber to reduce the volume of optical fiber exposed to radiation. Such a reduction is obtained in particular by improving amplification gain per unit length of the optical fiber.

A publication by Ma et al. entitled “Experimental investigation of radiation effect on erbium-ytterbium co-doped fiber amplifier for space optical communication in low-dose radiation environment,” Optics Express, Vol. 17, No. 18, pp. 15571-15577 (2009) proposes increasing amplification efficiency by doping using a combination of erbium and ytterbium. Such co-doping, however, increases the radiation sensitivity of the optical fiber. This increase in radiation sensitivity is caused, in part, by the phosphorus that is necessary for transferring energy from the ytterbium to the erbium and that is present in the composition of the central core matrix. Moreover, the Ma publication's solution is more costly than conventional doping with erbium, because it generally includes double-cladding structures suited to high-power applications.

A publication by Gusarov et al. entitled “Radiation sensitivity of EDFAs based on highly doped fibers,” Journal of Lightwave Technology, Vol. 27, No. 11, pp. 1540-1545 (2009) proposes increasing amplification efficiency by increasing the quantity of rare earths present in the optical fiber. If the concentration of rare earths in the central core of the optical fiber is high, however, pairs or even aggregates of rare earths are observed to form in the central core matrix leading to non-uniform doping. Such non-uniform doping reduces the amplification efficiency of the optical fiber because of the simultaneous existence of non-radiating mechanisms, such as quenching between the rare earths. Such processes of cooperation between rare earths include, for example, homogeneous up-conversion (HUC) and pair-induced quenching (PIQ). These mechanisms interfere with the stimulated emission of radiation producing the amplification. For example, in an optical fiber having a silica central core with an aluminum concentration of approximately 7 weight percent, the quenching phenomenon becomes important for an erbium concentration of 700 ppm. These unwanted transfers of energy compete with the emission stimulated by the pump beam, thereby limiting the amplification efficiency of the optical fiber.

Such aggregates of rare earths may also accentuate photonic degradation, such as photodarkening. Photonic degradation may occur during the propagation of high-power light signals in the optical fiber's central core because of highly absorbent defects present in the matrix of the central core.

To circumvent these aggregates, the Gusarov publication increases the quantity of complementary dopants. The reduction of the volume of optical fiber exposed to radiation may thus be rendered ineffective by this increase in the quantity of radiation-sensitive elements.

Erbium-doped amplifier optical fibers may employ holey claddings facilitate a reduction in the length of the optical fiber while retaining a high amplification gain. Holey claddings are known, for example, from the publication by Knight et al. entitled “All silica single-mode optical fiber with photonic crystal cladding,” Optics Letters, Vol. 21, pp. 1547-1549 (1996). Optical fibers including a holey cladding are referred to as photonic crystal optical fibers, holey optical fibers, microstructured optical fibers, or photonic crystal fibers (PCF). Holey optical fibers formed from multilayer film are known as Bragg fibers. Furthermore, some holey optical fibers confine transmitted signals using the forbidden energy band.

Photonic crystal fibers provide guidance by internal reflection via an array of air holes in the optical fiber's optical cladding. The optical fiber's central core can then be formed of pure silica (i.e., silica containing no dopants). The cladding is formed of pure silica with air holes, so it is not necessary to use dopants to obtain guidance properties.

For example, the publication by Cucinotta et al. entitled “Design of erbium-doped triangular photonic-crystal fiber based amplifiers,” IEEE Photonics Technology Letters, Vol. 16, No. 9, pp. 2027-2029 (2004) and the publication by K. Furusawa et al. entitled “High gain efficiency amplifier based on an erbium doped alumino-silicate holey fiber,” Optics Express, Vol. 12, No. 15, pp. 3452-3458 (2004) propose an optical fiber doped with erbium having a holey cladding. The holey cladding makes it possible to improve the amplification properties of the amplifying optical fibers. This amplification improvement is primarily because of the theoretical improvement of the overlap between the section doped with rare earths and both the pump and the signal beams. The Cucinotta and Furusawa publications, however, are not concerned with the radiation sensitivity of the optical fibers.

Optical fibers including a holey cladding are described in the publication by Hilaire et al. entitled “Numerical study of single mode Er-doped microstructured fibers: influence of geometrical parameters on amplifier performance,” Optics Express, Vol. 14, pp. 10865-10877 (2006). In the Hilaire publication, the reduction of the length of optical fiber relative to a standard erbium-doped optical fiber is as high as 40% while retaining the same gain curve. The optical fiber's profile is optimized to obtain a 90% overlap that varies only slightly with wavelength. The Hilaire publication, however, is not concerned with the sensitivity of the optical fiber to radiation.

The publication by S. Girard et al. entitled “Gamma-radiation induced attenuation in PCF,” Electronic Letters, Vol. 38, No. 20, pp. 1169-1171 (2002) indicates that the radiation sensitivity of photonic crystal fibers depends strongly on the purity of the silica used to produce the core. The publication by S. Girard et al. entitled “Radiation-induced defects in fluorine-doped silica-based optical fibers: Influence of pre-loading with H₂,” Journal of Non-Crystalline Solids, 355, pp. 1089-1091 (2009) shows that chlorine in the silica induces high absorption under radiation, particularly at short wavelengths. Those Girard publications, however, fail to describe amplifier optical fibers doped with rare earths. In particular, they do not deal with the problem of the spectral bandwidth of an amplifying optical fiber.

Therefore, a need exists for an optical fiber that has low sensitivity to radiation and non-degraded amplification properties.

### SUMMARY

In one aspect, the present invention embraces an amplifying optical fiber that includes a central core for transmitting and amplifying an optical signal, an optical cladding to confine the optical signal transmitted by the central core, and an outer cladding. The central core is formed of a core matrix and nanoparticles. The nanoparticles are formed of a nanoparticle matrix and rare earth dopants (i.e., a nanoparticle matrix surrounding the rare earth dopants). The optical cladding has a plurality of holes separated by a pitch and extending along the length of the optical fiber.

In an exemplary embodiment, the nanoparticle matrix includes a complementary dopant (e.g., aluminum, phosphorous, antimony, lanthanum, and/or bismuth).

In another exemplary embodiment, the core matrix does not include an additional dopant that is typically used to achieve a particular refractive index difference (e.g., germanium, fluorine, aluminum, and/or phosphorous).

In yet another exemplary embodiment, the optical cladding has a chlorine weight concentration of less than 500 part per million (ppm) and contains no other chemical elements (i.e., impurities) having a weight concentration greater than 1 part per billion (ppb).

In yet another exemplary embodiment, the optical cladding has a chlorine weight concentration of less than 100 ppm and contains no other chemical elements (i.e., impurities) having a weight concentration greater than 1 ppb.

In yet another exemplary embodiment, the optical cladding is pure silica.

In yet another exemplary embodiment, the holes and the central core have a symmetry of rotation about the optical fiber's center only of order π. Thus, rotating the optical fiber's cross-section by an angle of π around the optical fiber's central longitudinal axis results in an identical cross-section. Accordingly, the central core area has a size that is different in two main orthogonal directions.

In yet another exemplary embodiment, the holes are separated by a pitch of between about 2 microns and 10 microns.

In yet another exemplary embodiment, the holes have a cross-section that is substantially circular, and each hole has a diameter such that the ratio of the diameter to the pitch is between about 0.3 and 0.9.

In yet another exemplary embodiment, the core matrix is made of pure silica.

In yet another exemplary embodiment, the concentration of rare earth dopants in the central core is between about 200 ppm and 1000 ppm.

In yet another exemplary embodiment, the concentration of the nanoparticle matrix in the central core is between about 0.5 weight percent and 5 weight percent.

In yet another exemplary embodiment, the nanoparticles have an atomic ratio of the nanoparticle matrix to the rare earth dopants of between about 10 and 500.

In yet another exemplary embodiment, the nanoparticles have an atomic ratio of the nanoparticle matrix to the rare earth dopants of between about 50 and 350.

In yet another exemplary embodiment, the nanoparticle matrix is alumina (i.e., aluminum oxide or Al₂O₃) and/or silica.

In yet another exemplary embodiment, the rare earth dopants are erbium, ytterbium, and/or thulium.

In another aspect, the present invention embraces an optical amplifier. The optical amplifier typically includes an optical fiber in accordance with the first aspect of the invention. The optical amplifier uses a pump power of between about 150 milliwatts (mW) and 1.5 watts (W).

In an exemplary embodiment, the optical amplifier has a bandwidth of between about 25 nanometers and 32 nanometers in the C-band (i.e., from 1530 nanometers to 1560 nanometers).

In yet another aspect, the present invention embraces an optical fiber laser. The optical fiber laser typically includes an optical fiber in accordance with the first aspect of the invention.

In yet another aspect, the present invention embraces a method of manufacturing a primary optical preform. The method includes forming a preform core (i.e., the core of the preform) including nanoparticles containing rare earth dopants. The preform core contributes to the formation of a resulting optical fiber's central core. The method also includes fabricating a plurality of capillaries and arranging the capillaries around the preform core.

In an exemplary embodiment, the preform core is produced in a material based on pure silica.

In another exemplary embodiment, the capillaries have a chlorine concentration of less than 500 ppm and contain no other chemical elements (i.e., impurities) having a concentration greater than 1 ppb.

In yet another exemplary embodiment, the capillaries have a chlorine concentration of less than 100 ppm and contain no other chemical elements (i.e., impurities) having a concentration greater than 1 ppb.

In yet another exemplary embodiment, the capillaries are formed of pure silica.

In yet another exemplary embodiment, the preform core is formed by effecting a porous deposit (e.g., a deposit of soot) having a tubular shape on the inside surface of a tube. The porous deposit is impregnated with a suspension of nanoparticles containing rare earth dopants. The impregnated porous deposit is vitrified. The tube and vitrified, impregnated porous deposit are collapsed. The collapsed, vitrified, impregnated porous deposit is then extracted from the tube and is used to form the preform core.

In yet another exemplary embodiment, the porous deposit is effected via a modified chemical vapor deposition technique.

In yet another exemplary embodiment, the preform core is formed by forming a rod that includes nanoparticles containing rare earth dopants. The rod is vitrified and collapsed to form part of the preform core.

In yet another exemplary embodiment, the rod is produced via a sol-gel process.

In yet another exemplary embodiment, the capillaries are formed by effecting a tubular deposit (i.e., a deposit having a tubular shape) on the inside surface of a tube. The tubular deposit is extracted from the tube and the capillaries are drawn from the extracted tubular deposit.

In yet another exemplary embodiment, the tubular deposit is effected via a plasma chemical vapor deposition technique.

In yet another exemplary embodiment, the concentration of nanoparticles in the preform core is between about 10¹⁶ per cubic centimeter (cm⁻³) and 10¹⁸/cm³.

In yet another exemplary embodiment, the nanoparticles have a substantially spherical shape and a diameter of between about 5 nanometers and 25 nanometers.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 graphically depicts radiation-induced attenuation in an optical fiber as a function of the dopants present in the optical fiber and the wavelength of the signal transmitted by the optical fiber.

FIG. 2 schematically depicts a cross-sectional view of an exemplary optical fiber according to the present invention.

FIG. 3 schematically depicts a cross-sectional view of another exemplary optical fiber according to the present invention.

FIG. 4 schematically depicts a cross-sectional view of yet another exemplary optical fiber according to the present invention.

FIG. 5 schematically depicts an exemplary method of manufacturing a primary optical preform in accordance with the present invention.

FIG. 6 schematically depicts an exemplary method of manufacturing a preform core in accordance with the present invention.

FIG. 7 schematically depicts an exemplary method of manufacturing one or more capillaries in accordance with the present invention.

FIG. 8 schematically depicts a cross-sectional view of yet another exemplary optical fiber according to the present invention.

### DETAILED DESCRIPTION

In exemplary optical fibers according the present invention, the optical fiber is doped with rare earths by using nanoparticles containing rare earth dopants. Doping with nanoparticles typically makes it possible to limit or even eliminate the use of complementary dopants that are sensitive to radiation. Exemplary optical fibers also include an optical cladding with holes in it, also known as a holey cladding. The holes in the optical cladding make it possible to provide the guidance properties of the optical fiber without using radiation-sensitive dopants. Furthermore, the holes make it possible to reduce the length of optical fiber by increasing conversion efficiency. This reduces the length of optical fiber exposed to radiation. The optical fiber according to the present invention is thus highly insensitive to radiation. The characteristics of the optical fiber make it possible to obtain desirable radiation and amplification properties.

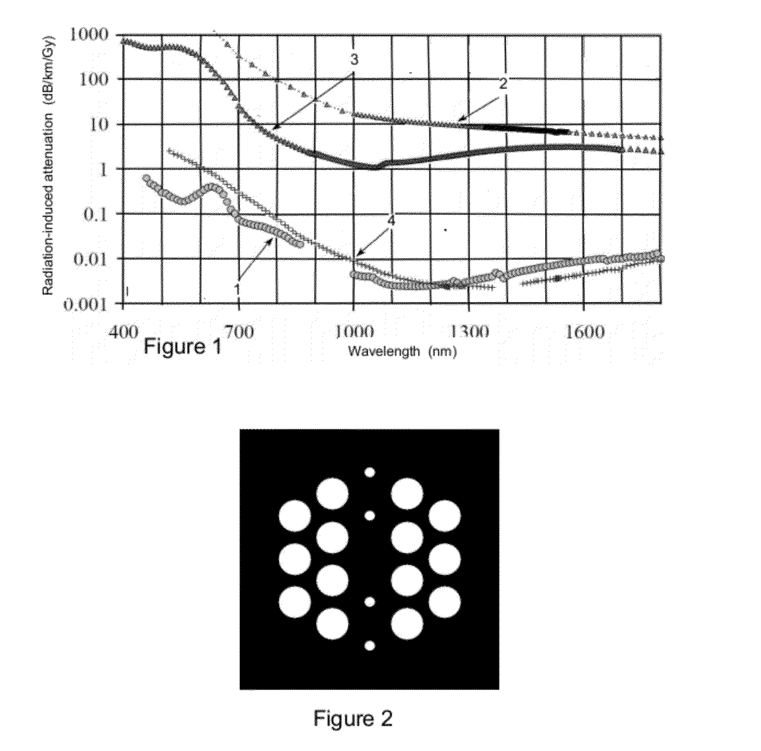

The optical fiber conforming to the present invention is described with reference to FIGS. 2, 3, 4, and 8, which are sectional views of exemplary optical fibers according to the present invention. These figures depict each optical fiber in a plane perpendicular to its axis.

The optical cladding is produced in a material adapted to transmit an optical signal, such as silica.

The optical cladding includes holes 10 that extend along the length of the optical fiber. In other words, the holes 10 extend in a direction parallel to the axis of the optical fiber. The holes 10 form a regular array of holes in which the axes of two adjacent holes are spaced at a pitch Λₕₒₗₑ.

In a transverse plane perpendicular to the axis of the optical fiber the sections of the holes 10 are organized in the form of a triangular periodic array. The periodic array is obtained from the repetition of a pattern of three holes whose centers form an equilateral triangle, except for a central area occupied by the core 11 of the optical fiber.

Also, in a practical realization of one exemplary embodiment, the holes 10 are arranged in concentric rings of holes. The term ring is to be understood here in the broadest sense, particularly including a substantially hexagonal shape as shown in FIGS. 2, 3, 4, and 8.

The examples shown in FIGS. 2, 3, 4, and 8 are not limiting on the invention. In particular, the holes 10 may be arranged in a different periodic array. The concentric rings may have a geometrical shape other than a hexagonal shape.

The holes 10 are filled with a gas, such as air or carbon dioxide (CO₂). The medium inside the holes 10 is different from the material between the holes 10. Thus the medium inside the holes 10 and the material around the holes 10 have different refractive indices. The number and volume of the holes 10 make it possible to adjust the refractive index of the optical cladding. Thus, the number and volume of the holes 10 make it possible to adjust the optical fiber's numerical aperture and the difference between the index of the optical fiber's central core 11 and that of optical fiber's optical cladding.

Thus, the holes 10 within the optical cladding make it possible to obtain a difference between the index of the central core 11 and the index of the optical cladding without using dopants. The optical signal is confined in the central core 11 without the presence of dopants. This reduces the quantity of dopants that are sensitive to radiation.

For example, in the particular embodiment shown in FIG. 8, the holes 10 have a cross-section that is circular with a diameter Φₕₒₗₑ. The pitch Λₕₒₗₑ is typically between about 2 microns and 10 microns. The ratio Φₕₒₗₑ/Λₕₒₗₑ is typically between about 0.3 and 0.9. The optical cladding has between two and six concentric hexagonal rings of holes.

In general, the holes 10 may vary because of uncertainties of the optical-fiber fabrication process. Thus, the holes 10 have a tolerance of 20 percent (e.g., 10 percent or less, such as 5 percent) with respect to the values of the pitch Λₕₒₗₑ and the diameter Φₕₒₗₑ. Accordingly, nominal values herein for pitch Λₕₒₗₑ and the diameter Φₕₒₗₑ include a 20-percent tolerance.

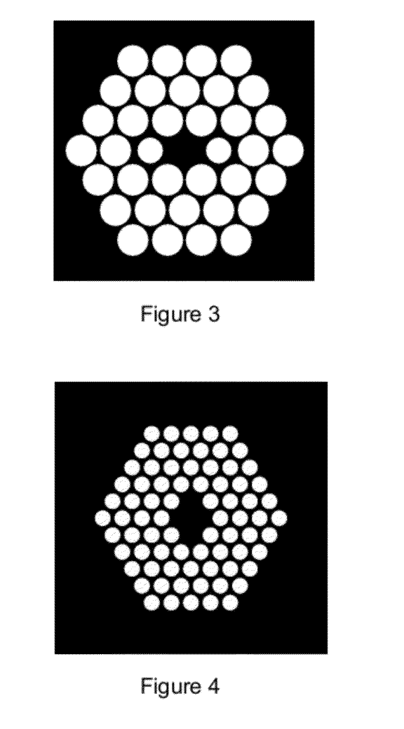

In other embodiments, the holes 10 have a circular cross-section and different diameters Φₕₒₗₑ. In the particular example shown in FIG. 2, holes with their center situated on a straight line passing through the center of the optical fiber have a diameter less than that of the other holes in the optical cladding. In another particular example shown in FIG. 3, diametrically-opposite holes in the first ring have a diameter less than that of the other holes.

As compared to standard dopant-based step index cladding technology, the holes 10 in the optical cladding make it possible to improve the overlap between the area 12 doped with rare earths and the pump optical beam and/or the overlap between the area 12 doped with rare earths and the signal optical beam. This improvement in the overlap between the area 12 doped with rare earths and the pump and/or the signal makes it possible to optimize the length of the optical fiber. For the same concentration of rare earths and for pump and signal beams having respective wavelengths of 980 nanometers and 1550 nanometers, the optical fiber of the present invention has a length reduced by in the range 20% to 50% compared with a prior art optical fiber in which the index difference between the central core 11 and the optical cladding is obtained with dopants. In other words, the optical fiber's amplification gain per unit length is greater than typical prior art optical fibers. Thus, a shorter length of optical fiber of the present invention is exposed to radiation than the exposed length of a prior art optical fiber.

The number and volume of the holes 10 furthermore determine other optical properties of the optical fiber. The pitch Λₕₒₗₑ has a value that achieves a compromise between the optical fiber's effective area and the optical fiber's bending losses. In this example, where the holes 10 have a circular cross-section and a diameter Φₕₒₗₑ, the pitch Λₕₒₗₑ and the ratio Φₕₒₗₑ/Λₕₒₗₑ further stabilize the single-mode behavior of the optical fiber for wavelengths used in the optical fiber (e.g., in amplification). Thus, the pitch Λhole and the ratio Φₕₒₗₑ/Λₕₒₗₑ ensure that the optical fiber's cut-off wavelength λ_{c} is less than the pump wavelength (e.g., 980 nanometers or 1480 nanometers for erbium).

The optical cladding has been described with holes 10 of circular cross-section, but the present invention is not so limited. In particular, the holes 10 may have a cross-sectional shape other than circular (e.g., a circle elongated in one direction, such as a pearl shape, or an elliptical shape).

The central core 11 is the optical fiber portion situated at the center of the optical fiber and surrounded by the optical cladding. In a plane perpendicular to the axis of the optical fiber, the central core 11 is the area within a circle that is tangential to the first ring of holes 10 from the center of the optical fiber.

In an exemplary embodiment, the central core 11 occupies a single point of the periodic array of points described above situated at the center of the optical fiber.

In a particular example of this embodiment, shown in FIG. 8, in which the holes 10 have a circular cross-section and a diameter Φₕₒₗₑ, the central core 11 has a circular section having a diameter 2r₁ equal to 2×Λₕₒₗₑ−Φₕₒₗₑ. Substituting this equation into the spatial relationships depicted in FIG. 8 yields the following equality: Λₕₒₗₑ=Φ_{doping}. This means that the outer diameter of the capillary tubes equals the outer diameter of the doped preform core, which would simplify manufacturing and ensure constant pitch within the holey cladding. Thus, in some exemplary embodiments, the doped preform core is manufactured to be have the largest possible diameter without disrupting pitch uniformity.

In other exemplary embodiments shown in FIGS. 2 and 3 in which the holes 10 of the first ring have different diameters, the core 11 has a cross-section of elliptical shape.

Another exemplary embodiment of the central core 11 includes the point of the array situated at the center of the optical fiber and one or more other points of the array. FIG. 4 shows one example of this embodiment. The central core 11 has a cross-section having substantially the shape of a quadrilateral.

The central core 11 includes a core matrix and nanoparticles. The core matrix surrounds the nanoparticles, which are doped with rare earths. The core matrix contributes to guiding the optical signal in the central core 11.

The core matrix typically contains no dopants. In particular, the core matrix contains no dopants for obtaining a refractive index difference between the central core 11 and the optical cladding. Thus, the core matrix does not contain dopants causing radiation-induced attenuation of the signal

The core matrix 11 has a chlorine concentration of less than 1000 ppm. Chlorine is typically used (e.g., in a material such as pure silica) to prevent contamination by hydroxide ions (OH⁻). Chlorine may also be present in the core matrix 11 as a residue from the raw materials (e.g., silicon tetrachloride) used in manufacturing. However, chlorine causes high radiation-induced adsorption in the range of visible wavelengths. Minimizing the quantity of chlorine in the optical fiber improves the optical fiber's resistance to radiation.

The core matrix 11 typically contains no other chemical elements (i.e., impurities) detectable by standard chemical analysis. The plasma torch or inductively coupled plasma (ICP) technique is one example of a chemical analysis technique. For example, the core matrix 11 contains no other chemical elements, such as metallic impurities or cations, having a weight concentration greater than 1 ppb. In other words, in the core matrix, the weight concentration of chemical elements (i.e., impurities) other than chlorine is less than 1 ppb.

Thus, the matrix of the central core 11 contains a limited quantity of chemical elements that could attenuate the signal transmitted by the optical fiber. In the core matrix, the radiation-induced attenuation of the signal is minimized. The core matrix contains no chemical elements inducing radiation losses greater than 0.05 decibels per meter per kilogray (dB/m/kGy) in the typical range of usable wavelengths. In this regard, the range of usable wavelengths refers to a range of wavelengths including the wavelength of the signal transmitted by the optical fiber. For erbium, for example, the usable range of wavelengths is from 900 nanometers to 1600 nanometers.

The core matrix is, for example, a vitreous matrix mostly of silica. The core matrix 11 is, for example, pure silica (i.e., silica containing no dopants).

The central core 11 further contains nanoparticles. The nanoparticles are surrounded by the core matrix. The doping of the central core 11 with rare earths is achieved via the nanoparticles.

The nanoparticles are contained within a central area 12 of the central core 11 having a substantially circular cross-section with diameter Φ_{doping}. The diameter Φ_{doping} of the doped area 12 is typically between about 2 microns and 10 microns. The diameter Φ_{doping} has a maximum value that makes it possible to preserve the constraints applying to the ratio Φₕₒₗₑ/Λₕₒₗₑ, particularly during optical-fiber fabrication.

The nanoparticles are formed from a nanoparticle matrix and embedded rare earth dopants. The nanoparticle matrix surrounds the rare earth dopants. The composition and structure of the nanoparticle matrix are favorable to the solubility of the rare earth dopants. This nanoparticle matrix is independent of the composition of the optical fiber's core matrix 11. For example, the nanoparticle matrix is typically silica or alumina, or a combination thereof.

The rare earth dopants make it possible to amplify the signal transmitted by the central core 11. In the optical fiber, the rare earth dopants take the ionized form of the same chemical element from the rare earths group. The rare earth dopant is, for example, erbium (Er), ytterbium (Yb), and/or thulium (Tm), or any other rare earth that facilitates amplification by optical pumping. For example, the rare earth is erbium for amplification in the C band.

Doping via nanoparticles makes it possible to avoid aggregation of the rare earth dopants. It is, therefore, not necessary to saturate the central core 11 with complementary dopants to prevent aggregation of the rare earths. Thus, the amplification properties are preserved while reducing the quantity of radiation-sensitive elements in the central core 11.

For example, the doped area 12 of the central core 11 has a concentration of rare earths of between about 200 and 1000 ppm and a nanoparticle matrix concentration between about 0.5 weight percent and 5 weight percent (e.g., between about 1.5 weight percent to 4 weight percent.

For example, the nanoparticles may have an atomic ratio of nanoparticle matrix to rare earth dopants of between about 10 and 500, typically between about 50 to 350 (e.g., 50 to 200).

The optical fiber also has a typical outer cladding. For example, the outer cladding is typically natural silica for reasons of cost. In another example, the exterior optical cladding is doped silica.

For the same amplification performance, the optical fiber of the present invention is 2 to 100 times, typically 10 to 1000 times, more resistant to radiation than a typical prior art optical fiber, depending on the radiation conditions and the optical fiber operating conditions. Thus, in the usable wavelength range, the optical fiber of the present invention has a radiation-induced attenuation of between about 0.005 dB/m/kGy and 0.05 dB/m/kGy.

Moreover, because of the small quantity of complementary dopants used, or even the absence of complementary dopants, the optical fiber of the present invention has low background losses before irradiation. Thus, in the wavelength range 1000 nanometers to 1200 nanometers, the background losses before irradiation are typically less than 5 decibels per kilometer (dB/km), or even less than 2 dB/km.

The optical fiber of the present invention is usable in low-bandwidth applications, such as single-channel applications, and in wide-bandwidth applications, such as wavelength-division multiplex applications, depending on the quantity of complementary dopants contained in the optical fiber, while remaining sufficiently insensitive to radiation.

In an exemplary embodiment, the nanoparticle matrix contains no complementary dopants. For example, the nanoparticle matrix is silica. The concentration of rare earth dopants in the nanoparticles is between about 150 ppm and 250 ppm. The optical fiber has a radiation-induced attenuation of between about 0.005 dB/m/kGy and 0.05 dB/m/kGy.

In an exemplary embodiment, the nanoparticle matrix contains complementary dopants that improve the dissolution of the rare earths at high concentrations, improve the gain properties of the optical fiber, and maintain a physical barrier between the rare earths. The complementary dopants make it possible to obtain a wide bandwidth without sacrificing radiation resistance.

In another exemplary embodiment, the nanoparticle matrix is an oxide, such as alumina, that facilitates the achievement of a good distribution of the rare earth dopants in the nanoparticle and makes it possible to widen the spectral window to provide amplification gain for wavelength-division multiplex applications. In this exemplary embodiment, the core 11 has a concentration of rare earth dopants of between about 200 ppm and 400 ppm and a concentration of complementary dopants of between about 2.5 weight percent and 3.5 weight percent. This facilitates the achievement of relatively wide bandwidth and low erbium-induced attenuation, which is proportional to the quantity of erbium present in the optical fiber. Accordingly, when doping with erbium, the exemplary optical fiber has an attenuation per unit length linked to the erbium of between about 3 decibels per meter (dB/m) and 6 dB/m at a wavelength of 1530 nanometers and a bandwidth of between about 25 nanometers and 32 nanometers.

The optical cladding, which includes the holes 10, transmits part of the fundamental optical mode and may interfere with the signal transmitted by the central core 11. The contribution of the optical cladding to the transmitted signal decreases rapidly with the radius of the optical fiber. In practice, the portion of the optical cladding including the first ring of holes 10 around the central core 11 contributes mainly to transmitting the optical signal. In the embodiment depicted in FIG. 8, the area that is likely to interfere with the transmitted signal is an annular area between the radii 0.5 Λₕₒₗₑ, and 1.5 Λₕₒₗₑ.

In an exemplary embodiment, the optical cladding has a chlorine concentration of about 500 ppm or less (e.g., about 100 ppm or less). The optical cladding typically contains no other chemical elements (i.e., impurities) detectable by standard chemical analysis techniques. The plasma torch or inductively coupled plasma (ICP) technique is one example of a chemical analysis technique. For example, the optical cladding contains no other chemical elements having a concentration higher than 1 ppb. In other words, the concentration of chemical elements (i.e., impurities) other than chlorine in the optical cladding is less than one ppb. Thus, the optical cladding contains a limited quantity of radiation-sensitive chemical elements that could attenuate the signal transmitted by the central core 11.

Thus, radiation-induced attenuation of the signal by the optical cladding is minimized. The optical cladding typically contains no chemical elements (i.e., impurities) inducing radiation losses greater than 0.05 decibels per meter per gray (dB/m/Gy).

In an exemplary embodiment, the area 12 doped with rare earths of diameter Φ_{doping} does not cover the entirety of the central core 11. In this embodiment, as compared to standard dopant-based step-index cladding technology, only the overlap between the central core 11 and the pump optical beam or the overlap between the central core 11 and the signal optical beam is improved. For example, the overlap is between 0.6 and 0.7.

In exemplary embodiments, the central core 11 and the holes 10 have a symmetry of rotation only of order π about the center of the optical fiber. Thus, rotating the optical fiber's cross-section by an angle of π around the optical fiber's central longitudinal axis results in the same cross-section. Accordingly, the central core area has a size that is different in two main orthogonal directions, thereby defining a fast axis and a slow axis generating a polarization maintaining optical fiber. For example, a triangular-lattice-based design in which two opposite holes in regard to the core, and belonging to the six holes of the first ring close to the core, have different size as compared to all the other holes would exhibit a symmetry of rotation of order π about the center of the optical fiber. Such rotation symmetry of order π makes it possible to preserve the polarization of the signal transmitted in the optical fiber. Thus, in such an embodiment of the optical fiber of the present invention, the optical cladding makes it possible to obtain a polarization-maintaining optical fiber without using additional dopants such as boron.

Typically, in an optical fiber in which the index difference between the central core and the optical cladding is obtained with dopants, the polarization of the transmitted signal is maintained by inserting rods of silica doped with boron into the optical cladding on either side of the central core.

FIGS. 2 to 4 show exemplary embodiments of optical fibers in which the holes 10 and the central core 11 have rotational symmetries only of order π. The FIG. 8 optical fiber example exhibits a symmetry of order π/3. The FIG. 8 optical fiber example does not have only a symmetry of order π and therefore is not a polarization-maintaining optical fiber.

The advantages of the optical fiber of the present invention are explained (below) with reference to the exemplary and comparative amplifier optical fibers I, II, III, and IV as set forth in Tables 1 and 2.

Fibers I and III are comparative optical fibers in which the refractive index difference between the central core and the optical cladding is obtained with dopants such as germanium and/or fluorine. The doping of the central core with rare earths is obtained without using nanoparticles by impregnation with a solution containing rare earths.

Fibers II and IV are exemplary optical fibers according to the present invention. The signal is confined in the central core 11 with the aid of the holes 10 in the optical cladding. In particular, in optical fibers II and IV the holes 10 are organized in a triangular array. The optical fibers II and IV are furthermore doped with erbium using nanoparticles.

Table 1 provides the characteristics of Fibers I and II, which are usable in a narrow-bandwidth application such as a single-channel application.

TABLE 1

| Fiber I (comparative) | | | Fiber II | | |
|---|---|---|---|---|---|
| λ_{c} | 960 | nm | λ_{c} | <960 | nm |
| 2r₁ | 2.5μ | | Pitch Λₕₒₗₑ | 6.0μ | |
| Δn | 30 × 10⁻³ | | Φₕₒₗₑ | 2.4μ | |
| | | | Φₕₒₗₑ/Λₕₒₗₑ | 0.4 | |
| [Er] | 1.6 × 10²⁴ | ions/m³ | [Er] | 1.6 × 10²⁴ | ions/m³ |
| | | | 2r₁ | 6.0μ | |
| α₁₅₃₀[Er] | 3 | dB/m | α₁₅₃₀[Er] | 4 | dB/m |
| | | | Δn_{doping} | 0 | |
| [Al] | ~0.3 | wt % | [Al] | 0 | |
| [Ge] | ~30 | wt % | [Ge] | 0 | |
| Γ_{980 nm} | 0.82 | | Γ_{980 nm} | 0.68 | |
| Γ_{1550 nm} | 0.53 | | Γ_{1550 nm} | 0.66 | |
| optical-fiber | 30 | m | optical-fiber | 23 | m |
| length | | | length | | |

For each optical fiber, Table 1 provides: the cut-off wavelength λ_{c}; the concentration of erbium [Er] in the central core; the central core's diameter 2r₁; the elemental aluminum concentration [Al]; the germanium concentration [Ge]; the overlaps Γ_{980 nm} and Γ_{1550 nm} between the doped section and, respectively, the pump beam of wavelength 980 nanometers and the signal beam of wavelength 1550 nanometers; and the length of the amplifying optical fiber.

Table 1 also provides the attenuation per meter α₁₅₃₀[Er] resulting from the incorporation of the erbium measured at the wavelength 1530 nanometers. This attenuation is different from the radiation-induced attenuation. The attenuation per unit length α₁₅₃₀[Er] depends on the concentration in erbium and the profile of the optical fiber.

For optical fiber I, Table 1 also provides the refractive index difference Δn between the central core and the optical cladding.

For optical fiber II, Table 1 provides: the pitch Λₕₒₗₑ between the holes 10 in the optical cladding; the diameter Φₕₒₗₑ of the holes 10; the ratio Φₕₒₗₑ/Λₕₒₗₑ between the diameter Φₕₒₗₑ and the pitch Λₕₒₗₑ; and the refractive index difference Δn_{doping} caused by the complementary dopants inserted into the central core.

In optical fiber I, the signal is confined in the central core 11 by doping the central core 11 with germanium, which contributes to the index difference Δn of the core.

In optical fiber II, the nanoparticles are formed of a matrix of silica (SiO₂) and erbium. Doping via nanoparticles makes it unnecessary to use aluminum to prevent aggregation of the rare earths. The doped area 12 thus contains no dopants that influence the refractive index difference (i.e., Δn_{doping} is zero). The pitch Λₕₒₗₑ between the holes 10 in the cladding is 6 microns. This pitch Λₕₒₗₑ makes it possible to simultaneously achieve acceptable values for the effective area of the optical fiber, the overlap between the doped area 12 and the signal and pump beams, and the resistance to bending losses.

The ratio Φₕₒₗₑ/Λₕₒₗₑ between the diameter Φₕₒₗₑ and the pitch Λₕₒₗₑ is 0.4. This value ensures stable single-mode behavior of the optical fiber and a cut-off wavelength λ_{c} that is less than the pump wavelength 960 nanometers. Optical fiber II includes 90 holes arranged in a triangular periodic array having rings.

The diameter 2r₁ of the core 11 is designed to a maximum value making it possible to preserve the ratio Φₕₒₗₑ/Λₕₒₗₑ in the change from the preform to the optical fiber during fabrication of the optical fiber (i.e., considering the thickness of the walls of the capillary tubes).

Optical fibers I and II have the same erbium concentration. However, by virtue of its characteristics, optical fiber II contains less radiation-sensitive dopant than optical fiber I. Doping with rare earths via nanoparticles makes it possible to forgo the use of aluminum, and the holes 10 in the optical cladding make it possible to forgo the use of germanium. Thus, optical fiber II contains no radiation-sensitive dopants other than erbium.

Furthermore, the holes 10 facilitate the achievement of a higher amplification gain per unit length than a comparative optical fiber, thereby making it possible to improve the overlap between the signal and the area 12 doped with erbium. This in turn, reduces the exposed length of optical fiber for a given desired amplification gain. Thus, in practice, exemplary optical fiber II has less length exposed to radiation than that of optical fiber I in a given application. Exemplary optical fiber II of the present invention, therefore, has reduced radiation sensitivity compared with conventional optical fiber I. The attenuation per meter α₁₅₃₀[Er] of optical fiber II at the wavelength 1530 nanometers caused by the incorporation of the erbium is greater than that of optical fiber I because of the improved overlap between the doped area and the optical signal at the wavelength concerned.

Table 2 (below) provides the characteristics of optical fibers III and IV, which are usable in a wide-band application such as a wavelength-division multiplex application. The aluminum concentration is higher than in optical fibers I and II to increase the bandwidth.

TABLE 2

| Fiber III (comparative) | | | Fiber IV | | |
|---|---|---|---|---|---|
| λ_{c} | 960 | nm | λ_{c} | <960 | nm |
| 2r₁ | 3.2μ | | Pitch Λₕₒₗₑ | 6.0μ | |
| Δn | 19 × 10⁻³ | | Φₕₒₗₑ | 2.4μ | |
| | | | Φₕₒₗₑ/Λₕₒₗₑ | 0.4 | |
| [Er] | 2.0 × 10²⁴ | ions/m³ | [Er] | 2.0 × 10²⁴ | ions/m³ |
| | | | 2r₁ | 6.0μ | |
| α₁₅₃₀[Er] | 4 | dB/m | α₁₅₃₀[Er] | 6.1 | dB/m |
| | | | Δn_{doping} | 10 × 10⁻³ | |
| [Al] | ~7 | wt % | [Al] | ~3 | wt % |
| [F] | ~1.0 | wt % | [F] | 0 | |
| [Ge] | ~0.5 | wt % | [Ge] | 0 | |
| Γ_{980 nm} | 0.83 | | Γ_{980 nm} | 0.92 | |
| Γ_{1550 nm} | 0.55 | | Γ_{1550 nm} | 0.84 | |
| optical-fiber | 23 | m | optical-fiber | 15 | m |
| length | | | length | | |

Table 2 provides the same parameters as Table 1, as well as each optical fiber's fluorine concentration [F].

In comparative optical fiber III, most of the refractive index difference between the central core and the optical cladding is produced by the aluminum inserted to prevent aggregation of the rare earths. That said, some of the refractive index difference is produced by complementary codoping of the central core with germanium and doping of the cladding with fluorine.

In exemplary optical fiber IV, the nanoparticles are formed of an alumina matrix containing erbium. The alumina induces a refractive index difference Δn_{doping}. The characteristics of the pitch Λₕₒₗₑ between the holes, the ratio Φₕₒₗₑ/Λₕₒₗₑ between the diameter Φₕₒₗₑ and the pitch Λₕₒₗₑ, and the diameter Φdoping are identical to those of optical fiber II. Optical fiber IV includes 90 holes arranged in a triangular periodic array having 5 rings.

Optical fibers III and IV have the same erbium concentration. However, by virtue of its characteristics, optical fiber IV contains less radiation-sensitive dopant than does optical fiber III. Doping with rare earths via nanoparticles makes it possible to reduce the quantity of alumina necessary to obtain a large bandwidth. The holes 10 in the optical cladding also make it possible to eliminate the fluorine and the germanium that are typically necessary to obtain guidance properties. Thus, exemplary optical fiber IV contains less radiation-sensitive dopant than does comparative optical fiber III. The holes 10 of the optical cladding also make it possible to reduce the length of optical fiber. Thus, exemplary optical fiber IV of the present invention has less length exposed to radiation than that of optical fiber III in a given application. Exemplary optical fiber IV of the present invention, therefore, has a reduced radiation sensitivity as compared to conventional optical fiber III. The attenuation per meter α₁₅₃₀[Er] of optical fiber IV measured at the wavelength 1530 nanometers and caused by incorporating erbium is greater than that of optical fiber III because of the improved overlap between the doped area and the optical signal at the wavelength concerned.

The present invention also embraces an optical amplifier including at least one portion of an optical fiber according to the present invention and using a pump power of between about 150 mW and 1500 mW. In an exemplary embodiment, the amplifier has a bandwidth from 28 nanometers to 32 nanometers in the C band (from 1530 nanometers to 1560 nanometers).

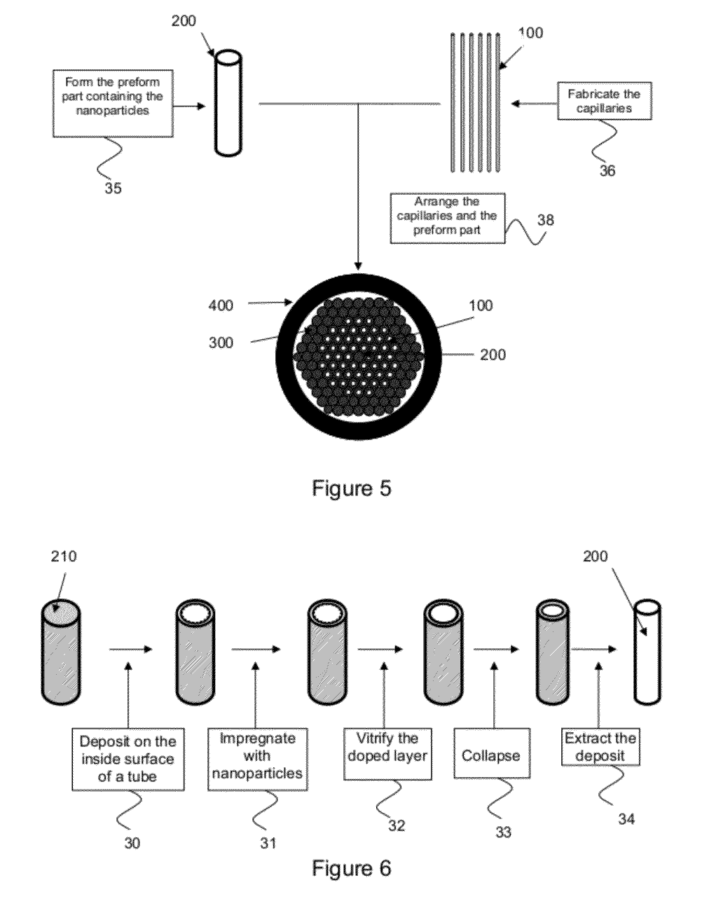

The present invention further relates to a method of fabricating a primary optical preform as described above. The method is explained with reference to FIGS. 5 to 7.

As FIG. 5 shows, the method includes a step 35 of forming a preform core 200 containing nanoparticles doped with rare earths. The preform core 200 contributes to forming the optical fiber's central core 11 after drawing the preform. For example, the concentration of rare earth dopants in the preform core 200 is between about 200 ppm and 1000 ppm, and the concentration of the nanoparticle matrix in the preform core 200 is between about 0.5 weight percent and 5 weight percent (e.g., between about 1.5 weight percent and 4 weight percent).

The preform core 200 typically has a chlorine concentration of less than 1000 ppm. The preform core 200 typically contains no other chemical elements (i.e., impurities) detectable by standard chemical analysis techniques. The plasma torch or inductively coupled plasma (ICP) is one example of a chemical analysis process. For example, the preform core 200 contains no other chemical elements (i.e., impurities) having a concentration greater than 1 ppb. Minimizing the quantity of chlorine and other chemical elements in the preform core 200 increases the radiation-resistance of the optical fiber obtained after drawing.

The method includes a step 36 of fabricating capillaries 100. These capillaries 100 define the holes 10 of the optical fiber obtained after drawing the preform.

A step 38 may follow in which the capillaries 100 are arranged in bundles of capillaries with the preform core 200 at the center of the bundle. Thus, the preform includes elements which, after drawing, constitute the holes 10 and the central core 11 of the optical fiber.

The exemplary method facilitates the manufacture of a preform that, after drawing, produces an optical fiber with a central core 11 containing nanoparticles doped with rare earths and a holey cladding. The exemplary method of the present invention also facilitates the manufacture of a preform of a radiation-resistant optical fiber having very favorable amplification performance.

The preform then undergoes typical steps of fabricating a photonic crystal optical fiber. For example, the combination of the preform core 200 and the capillaries 100 is completed by rods 300 and cladding 400 forming the outer cladding after drawing.

In an exemplary embodiment, the capillaries 100 have a chlorine concentration of about 500 ppm or less (e.g., about 100 ppm or less). The capillaries 100 moreover contain no other chemical elements (i.e., impurities) detectable by standard chemical analysis techniques, such as the plasma torch. For example, the capillaries 100 contain no other chemical elements (i.e., impurities) having a concentration greater than 1 ppb. In other words, in the capillaries 100 the concentration of chemical elements other than chlorine (i.e., impurities) is less than 1 ppb. Thus, the capillaries 100 contain a limited quantity of radiation-sensitive chemical elements to that would attenuate the signal transmitted by the central core 11 of the optical fiber obtained after drawing. The capillaries 100 may be pure silica.

In another exemplary embodiment depicted in FIG. 6, the step 35 may include a step 30 of effecting a porous deposit on the inside surface of a tube 210. The porous deposit, which conforms to this inside surface, is therefore of tubular shape. For example, the porous deposit is made of pure silica. The deposit may be obtained using a modified chemical vapor deposition (MCVD) phase. The step 35 then includes a step 31 of impregnating the porous deposit with a suspension of nanoparticles. These nanoparticles are doped with rare earths. The step 35 then includes a step 32 of vitrifying the porous deposit at a high temperature, for example at a temperature of 2000° C. The step 35 then includes a step 33 of collapsing the combination of the tube 210 and the porous deposit. As noted, the porous deposit is initially of tubular shape. During the step 33, the porous deposit is collapsed. Thus, after this step 33, the porous deposit no longer has a tubular shape but assumes a solid cylindrical shape.

In this exemplary embodiment, the step 35 then includes a step 34 of extracting the porous deposit. In other words, the tube 210 is removed. Consequently, the tube 210 is not present in the optical fiber obtained after drawing the preform. Thus, the content of impurities of the tube 210 does not adversely affect the optical characteristics of the optical fiber after drawing. By way of non-limiting example, the tube 210 may be removed by evaporation, machining, or etching, or by a combination of these three techniques. The porous deposit extracted from the tube 210 therefore constitutes the part 200 of the preform comprising the nanoparticles doped with rare earths. As noted, the preform core 200 contributes to forming the central core 11 of the optical fiber after drawing.

In yet another exemplary embodiment, the step 35 includes a step of forming a rod containing nanoparticles doped with rare earths. The rod is, for example, in the shape of a solid cylinder. The rod is based on pure silica. The rod is produced, for example, via sol-gel process. The step 35 then includes a step of vitrification at a temperature of about 1000° C. or greater followed by a step of collapsing the rod. The rod thus forms the preform core 200 including nanoparticles doped with rare earths. As noted, the preform core 200 contributes to forming the central core 11 of the optical fiber after drawing.

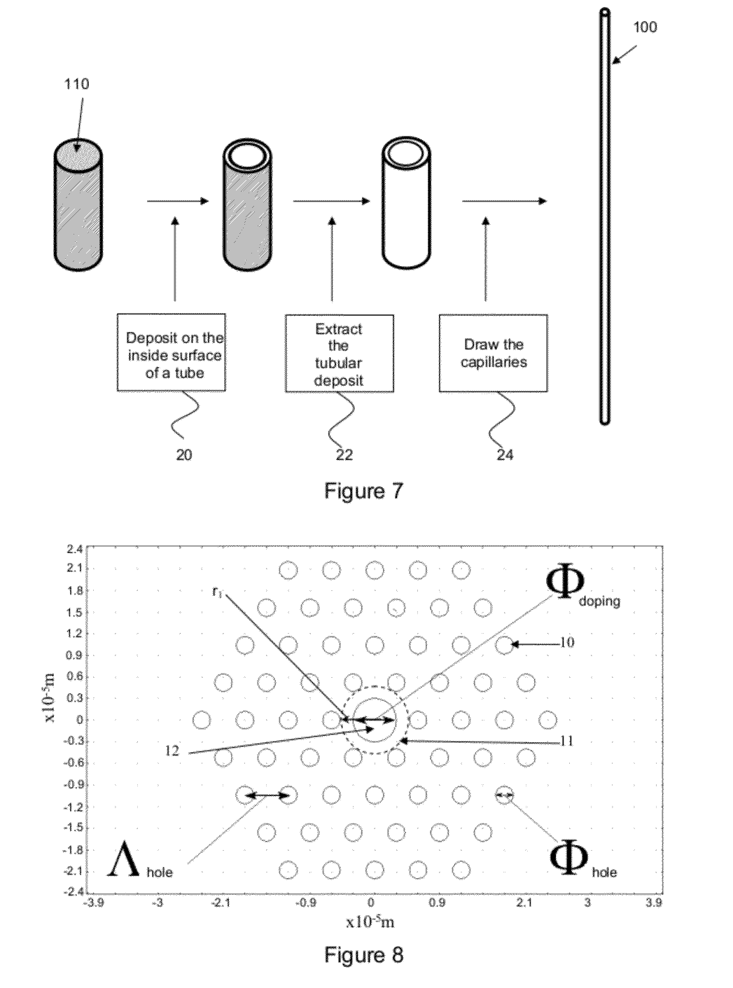

In yet another exemplary embodiment, the step 36 of fabricating the capillaries 100 includes additional steps described with reference to FIG. 7. The step 36 of fabricating the capillaries 100 includes a step 20 of effecting a deposit on the inside surface of a tube 110. The deposit is produced, for example, using a plasma-activated chemical vapor deposition (PCVD) technique. The step 36 of fabricating the capillaries 100 then includes a step 22 of extracting the tubular deposit, i.e., removing the tube 110 to retain only the deposit. By way of non-limiting example, the tube 110 is removed by machining or etching, or a combination of these two methods. There follows the drawing of the capillaries 100 (step 24) from the tubular deposit. The tube 110 is not present in the capillaries 100 obtained. Thus, the level of impurities of the tube 110 does not adversely affect the optical characteristics of the optical fiber after drawing.

In some exemplary embodiments, the deposit on the inside surface of the tube 110 has a chlorine concentration of about 500 ppm or less (e.g., about 100 ppm or less). The deposit further contains no other chemical elements (i.e., impurities) detectable by standard chemical analysis techniques, such as via plasma torch. For example, the deposit contains no other chemical elements (i.e., impurities) having a concentration greater than 1 ppb. Minimizing the quantity of chlorine and other chemical elements in the deposit improves the radiation resistance of the optical fiber obtained after drawing.

In yet another exemplary embodiment, the step 36 of fabricating the capillaries 100 includes the step 20 of effecting a deposit on the inside surface of a tube 110. The step 36 then includes drawing the capillaries 100 (step 24) from the combination of the tube 110 and the tubular deposit. In this exemplary embodiment, the tube 110 is present in the capillaries 100 obtained. This simplifies the method of fabricating the capillaries 100.

In some exemplary embodiments, the tube 110 and the deposit on the inside surface of the tube 110 each have a chlorine concentration of about 500 ppm or less (e.g., about 100 ppm or less). The tube 110 and the deposit furthermore contain no other chemical elements (i.e., impurities) detectable by standard chemical analysis techniques, such as via plasma torch. For example, the tube 110 and the deposit contain no other chemical elements (i.e., impurities) having a concentration greater than 1 ppb. Minimizing the quantity of chlorine and other chemical elements in the tube 110 and the deposit improves the radiation resistance of the optical fiber obtained after drawing.

The nanoparticles may be produced by chemical or physical synthesis. Producing the nanoparticles by chemical synthesis encourages the formation of thermodynamically stable stoichiometric structures.

A typical chemical method may be used for chemical synthesis of the nanoparticles in a controlled pH aqueous solution by co-precipitation of precursors of alumina salts (when the nanoparticle matrix is in alumina) and rare earth salts. For example, the precursors of alumina are inorganic salts, such as nitrate or chloride, and the precursors of erbium, ytterbium, and thulium are organic salts, such as acetyl acetonate, or acetate. The atomic ratio of the alumina salts to rare earth salts precursors is typically between about 10 and 500 (e.g., between about 50 and 350). Such atomic ratios may yield a concentration of the rare earth dopants in each nanoparticle of between about 0.5 weight percent and 3 weight percent (e.g., between about 0.75 weight percent and 1.5 weight percent) depending on the target applications and the rare earth dopants chosen. In a particular example, the atomic ratio of the alumina salt precursors to rare earth salt precursors is between about 50 and 200.

In an exemplary embodiment, the nanoparticle matrix is alumina, the rare earth dopant is erbium, and the atomic ratio of alumina to erbium is between about 10 and 500, such as between about 50 and 350 (e.g., between about 50 and 200).

The nanoparticles are washed and dispersed in an aqueous or alcohol-based solution with a nanoparticle concentration of between about 10¹⁶ and 10¹⁸ per cm³ depending on the size of the nanoparticles. For example, the nanoparticles have a substantially spherical shape and diameters of between about 5 nanometers and 25 nanometers (e.g., 10-20 nanometers). A tolerance of 20 percent is acceptable for the characteristics of the nanoparticles. For example, the nanoparticles are dispersed in the aqueous or alcohol-based solution with a nanoparticle concentration greater than or equal to 10¹⁷ per cm³ for nanoparticles of 5 nanometers diameter and greater than or equal to 10¹⁶ per cm³ for nanoparticles of 10 nanometers diameter.

In general, at least 80 percent (e.g., at least 85 percent) of the nanoparticles—and typically 90 percent (e.g., at least 95 percent) of the nanoparticles—exhibit the nominal nanoparticle characteristics (e.g., shapes, dimensions, and constituent concentrations).

For the matrix of each nanoparticle to be present in the finished optical fiber and to be able to constitute a physical barrier between the rare earths, it is important for each nanoparticle to withstand the optical fiber fabrication conditions (temperatures and stresses). For example, a particular embodiment of the method according to the present invention includes a step of thermally densifying the nanoparticles after they are incorporated in the porous deposit 210 by impregnation and before vitrification of the deposit. The deposit 210 undergoes a heat treatment at a temperature greater than 1000° C. for at least one hour to reinforce the structure of the nanoparticles.

The present optical fibers may be manufactured by drawing from final preforms.

A final preform may be manufactured by providing a primary preform with an outer overcladding layer (i.e., an overcladding process). The outer overcladding layer typically consists of doped or undoped, natural or synthetic, silica glass. Several methods are available for providing the outer overcladding layer.

In a first exemplary method, the outer overcladding layer may be provided by depositing and vitrifying natural or synthetic silica particles on the outer periphery of the primary preform under the influence of heat. Such a process is known, for example, from U.S. Pat. Nos. 5,522,007, 5,194,714, 6,269,663, and 6,202,447, each of which is hereby incorporated by reference in its entirety.

In another exemplary method, a primary preform may be overcladded using a silica sleeve tube, which may or may not be doped. This sleeve tube may then be collapsed onto the primary preform.

In yet another exemplary method, an overcladding layer may be applied via an Outside Vapor Deposition (OVD) method. Here, a soot layer is first deposited on the outer periphery of a primary preform, and then the soot layer is vitrified to form glass.

The primary preforms may be manufactured via outside vapor deposition techniques, such as Outside Vapor Deposition (OVD) and Vapor Axial Deposition (VAD). Alternatively, the primary preforms may be manufactured via inside deposition techniques in which glass layers are deposited on the inner surface of a substrate tube of doped or undoped silica glass, such as Modified Chemical Vapor Deposition (MCVD), Furnace Chemical Vapor Deposition (FCVD), and Plasma Chemical Vapor Deposition (PCVD).

By way of example, the primary preforms may be manufactured using a PCVD process, which can precisely control the central core's gradient refractive index profile.

To supplement the present disclosure, this application incorporates entirely by reference the following commonly assigned patents, patent application publications, and patent applications: U.S. Pat. No. 4,838,643 for a Single Mode Bend Insensitive Fiber for Use in Fiber Optic Guidance Applications (Hodges et al.); U.S. Pat. No. 7,623,747 for a Single Mode Optical Fiber (de Montmorillon et al.); U.S. Pat. No. 7,587,111 for a Single-Mode Optical Fiber (de Montmorillon et al.); U.S. Pat. No. 7,356,234 for a Chromatic Dispersion Compensating Fiber (de Montmorillon et al.); U.S. Pat. No. 7,483,613 for a Chromatic Dispersion Compensating Fiber (Bigot-Astruc et al.); U.S. Pat. No. 7,526,177 for a Fluorine-Doped Optical Fiber (Matthijsse et al.); U.S. Pat. No. 7,555,186 for an Optical Fiber (Flammer et al.); U.S. Patent Application Publication No. US2009/0252469 A1 for a Dispersion-Shifted Optical Fiber (Sillard et al.); U.S. Pat. No. 8,041,172 for a Transmission Optical Fiber Having Large Effective Area (Sillard et al.); International Patent Application Publication No. WO 2009/062131 A1 for a Microbend-Resistant Optical Fiber, (Overton); U.S. Patent Application Publication No. US2009/0175583 A1 for a Microbend-Resistant Optical Fiber, (Overton); U.S. Patent Application Publication No. US2009/0279835 A1 for a Single-Mode Optical Fiber Having Reduced Bending Losses, filed May 6, 2009, (de Montmorillon et al.); U.S. Pat. No. 7,889,960 for a Bend-Insensitive Single-Mode Optical Fiber, (de Montmorillon et al.); U.S. Patent Application Publication No. US2010/0021170 A1 for a Wavelength Multiplexed Optical System with Multimode Optical Fibers, filed Jun. 23, 2009, (Lumineau et al.); U.S. Pat. No. 7,995,888 for a Multimode Optical Fibers, filed Jul. 7, 2009, (Gholami et al.); U.S. Patent Application Publication No. US2010/0119202 A1 for a Reduced-Diameter Optical Fiber, filed Nov. 6, 2009, (Overton); U.S. Patent Application Publication No. US2010/0142969 A1 for a Multimode Optical System, filed Nov. 6, 2009, (Gholami et al.); U.S. Patent Application Publication No. US2010/0118388 A1 for an Amplifying Optical Fiber and Method of Manufacturing, filed Nov. 12, 2009, (Pastouret et al.); U.S. Patent Application Publication No. US2010/0135627 A1 for an Amplifying Optical Fiber and Production Method, filed Dec. 2, 2009, (Pastouret et al.); U.S. Patent Application Publication No. US2010/0142033 for an Ionizing Radiation-Resistant Optical Fiber Amplifier, filed Dec. 8, 2009, (Regnier et al.); U.S. Patent Application Publication No. US2010/0150505 A1 for a Buffered Optical Fiber, filed Dec. 11, 2009, (Testu et al.); U.S. Patent Application Publication No. US2010/0171945 for a Method of Classifying a Graded-Index Multimode Optical Fiber, filed Jan. 7, 2010, (Gholami et al.); U.S. Patent Application Publication No. US2010/0189397 A1 for a Single-Mode Optical Fiber, filed Jan. 22, 2010, (Richard et al.); U.S. Patent Application Publication No. US2010/0189399 A1 for a Single-Mode Optical Fiber Having an Enlarged Effective Area, filed Jan. 27, 2010, (Sillard et al.); U.S. Patent Application Publication No. US2010/0189400 A1 for a Single-Mode Optical Fiber, filed Jan. 27, 2010, (Sillard et al.); U.S. Patent Application Publication No. US2010/0214649 A1 for an Optical Fiber Amplifier Having Nanostructures, filed Feb. 19, 2010, (Burov et al.); U.S. Pat. No. 8,009,950 for a Multimode Fiber, filed Apr. 22, 2010, (Molin et al.); U.S. Patent Application Publication No. US2010/0310218 A1 for a Large Bandwidth Multimode Optical Fiber Having a Reduced Cladding Effect, filed Jun. 4, 2010, (Molin et al.); U.S. Patent Application Publication No. US2011/0058781 A1 for a Multimode Optical Fiber Having Improved Bending Losses, filed Sep. 9, 2010, (Molin et al.); U.S. Patent Application Publication No. US2011/0064367 A1 for a Multimode Optical Fiber, filed Sep. 17, 2010, (Molin et al.); U.S. Patent Application Publication No. US2011/0069724 A1 for an Optical Fiber for Sum-Frequency Generation, filed Sep. 22, 2010, (Richard et al.); U.S. Patent Publication No. US2011/0116160 A1 for a Rare-Earth-Doped Optical Fiber Having Small Numerical Aperture, filed Nov. 11, 2010, (Boivin et al.); U.S. Patent Publication No. US2011/0123161 A1 for a High-Bandwidth, Multimode Optical Fiber with Reduced Cladding Effect, filed Nov. 24, 2010, (Molin et al.); U.S. Patent Publication No. US2011/0123162 A1 for a High-Bandwidth, Dual-Trench-Assisted Multimode Optical Fiber, filed Nov. 24, 2010, (Molin et al.); U.S. Patent Publication No. US2011/0135262 A1 for a Multimode Optical Fiber with Low Bending Losses and Reduced Cladding Effect, filed Dec. 3, 2010, (Molin et al.); U.S. Patent Publication No. US2011/0135263 A1 for a High-Bandwidth Multimode Optical Fiber Having Reduced Bending Losses, filed Dec. 3, 2010, (Molin et al.); U.S. Patent Publication No. US2011/0188826 A1 for a Non-Zero Dispersion Shifted Optical Fiber Having a Large Effective Area, filed Jan. 31, 2011, (Sillard et al.); U.S. Patent Publication No. US2011/0188823 A1 for a Non-Zero Dispersion Shifted Optical Fiber Having a Short Cutoff Wavelength, filed Jan. 31, 2011, (Sillard et al.); U.S. Patent Publication No. 2011/0217012 A1 for a Broad-Bandwidth Multimode Optical Fiber Having Reduced Bending Losses, filed Mar. 1, 2011, (Bigot-Astruc et al.); U.S. Patent Publication No. 2011/0229101 A1 for a Single-Mode Optical Fiber, filed Mar. 15, 2011, (de Montmorillon et al.); U.S. patent application Ser. No. 13/175,181 for a Single-Mode Optical Fiber, filed Jul. 1, 2011, (Bigot-Astruc et al.); U.S. patent application Ser. No. 13/206,943 for a Method of Fabricating an Optical Fiber Preform, filed Aug. 10, 2011, (de Montmorillon et al.); and U.S. patent application Ser. No. 13/275,921 for a Multimode Optical Fiber Insensitive to Bending Losses, filed Oct. 18, 2011, (Molin et al.).

To supplement the present disclosure, this application further incorporates entirely by reference the following commonly assigned patents, patent application publications, and patent applications: U.S. Pat. No. 5,574,816 for Polypropylene-Polyethylene Copolymer Buffer Tubes for Optical Fiber Cables and Method for Making the Same; U.S. Pat. No. 5,717,805 for Stress Concentrations in an Optical Fiber Ribbon to Facilitate Separation of Ribbon Matrix Material; U.S. Pat. No. 5,761,362 for Polypropylene-Polyethylene Copolymer Buffer Tubes for Optical Fiber Cables and Method for Making the Same; U.S. Pat. No. 5,911,023 for Polyolefin Materials Suitable for Optical Fiber Cable Components; U.S. Pat. No. 5,982,968 for Stress Concentrations in an Optical Fiber Ribbon to Facilitate Separation of Ribbon Matrix Material; U.S. Pat. No. 6,035,087 for an Optical Unit for Fiber Optic Cables; U.S. Pat. No. 6,066,397 for Polypropylene Filler Rods for Optical Fiber Communications Cables; U.S. Pat. No. 6,175,677 for an Optical Fiber Multi-Ribbon and Method for Making the Same; U.S. Pat. No. 6,085,009 for Water Blocking Gels Compatible with Polyolefin Optical Fiber Cable Buffer Tubes and Cables Made Therewith; U.S. Pat. No. 6,215,931 for Flexible Thermoplastic Polyolefin Elastomers for Buffering Transmission Elements in a Telecommunications Cable; U.S. Pat. No. 6,134,363 for a Method for Accessing Optical Fibers in the Midspan Region of an Optical Fiber Cable; U.S. Pat. No. 6,381,390 for a Color-Coded Optical Fiber Ribbon and Die for Making the Same; U.S. Pat. No. 6,181,857 for a Method for Accessing Optical Fibers Contained in a Sheath; U.S. Pat. No. 6,314,224 for a Thick-Walled Cable Jacket with Non-Circular Cavity Cross Section; U.S. Pat. No. 6,334,016 for an Optical Fiber Ribbon Matrix Material Having Optimal Handling Characteristics; U.S. Pat. No. 6,321,012 for an Optical Fiber Having Water Swellable Material for Identifying Grouping of Fiber Groups; U.S. Pat. No. 6,321,014 for a Method for Manufacturing Optical Fiber Ribbon; U.S. Pat. No. 6,210,802 for Polypropylene Filler Rods for Optical Fiber Communications Cables; U.S. Pat. No. 6,493,491 for an Optical prop Cable for Aerial Installation; U.S. Pat. No. 7,346,244 for a Coated Central Strength Member for Fiber Optic Cables with Reduced Shrinkage; U.S. Pat. No. 6,658,184 for a Protective Skin for Optical Fibers; U.S. Pat. No. 6,603,908 for a Buffer Tube that Results in Easy Access to and Low Attenuation of Fibers Disposed Within Buffer Tube; U.S. Pat. No. 7,045,010 for an Applicator for High-Speed Gel Buffering of Flextube Optical Fiber Bundles; U.S. Pat. No. 6,749,446 for an Optical Fiber Cable with Cushion Members Protecting Optical Fiber Ribbon Stack; U.S. Pat. No. 6,922,515 for a Method and Apparatus to Reduce Variation of Excess Fiber Length in Buffer Tubes of Fiber Optic Cables; U.S. Pat. No. 6,618,538 for a Method and Apparatus to Reduce Variation of Excess Fiber Length in Buffer Tubes of Fiber Optic Cables; U.S. Pat. No. 7,322,122 for a Method and Apparatus for Curing a Fiber Having at Least Two Fiber Coating Curing Stages; U.S. Pat. No. 6,912,347 for an Optimized Fiber Optic Cable Suitable for Microduct Blown Installation; U.S. Pat. No. 6,941,049 for a Fiber Optic Cable Having No Rigid Strength Members and a Reduced Coefficient of Thermal Expansion; U.S. Pat. No. 7,162,128 for Use of Buffer Tube Coupling Coil to Prevent Fiber Retraction; U.S. Pat. No. 7,515,795 for a Water-Swellable Tape, Adhesive-Backed for Coupling When Used Inside a Buffer Tube (Overton et al.); U.S. Patent Application Publication No. 2008/0292262 for a Grease-Free Buffer Optical Fiber Buffer Tube Construction Utilizing a Water-Swellable, Texturized Yarn (Overton et al.); European Patent Application Publication No. 1,921,478 A1, for a Telecommunication Optical Fiber Cable (Tatat et al.); U.S. Pat. No. 7,702,204 for a Method for Manufacturing an Optical Fiber Preform (Gonnet et al.); U.S. Pat. No. 7,570,852 for an Optical Fiber Cable Suited for Blown Installation or Pushing Installation in Microducts of Small Diameter (Nothofer et al.); U.S. Pat. No. 7,646,954 for an Optical Fiber Telecommunications Cable (Tatat); U.S. Pat. No. 7,599,589 for a Gel-Free Buffer Tube with Adhesively Coupled Optical Element (Overton et al.); U.S. Pat. No. 7,567,739 for a Fiber Optic Cable Having a Water-Swellable Element (Overton); U.S. Pat. No. 7,817,891 for a Method for Accessing Optical Fibers within a Telecommunication Cable (Lavenne et al.); U.S. Pat. No. 7,639,915 for an Optical Fiber Cable Having a Deformable Coupling Element (Parris et al.); U.S. Pat. No. 7,646,952 for an Optical Fiber Cable Having Raised Coupling Supports (Parris); U.S. Pat. No. 7,724,998 for a Coupling Composition for Optical Fiber Cables (Parris et al.); U.S. Patent Application Publication No. US2009/0214167 A1 for a Buffer Tube with Hollow Channels, (Lookadoo et al.); U.S. Patent Application Publication No. US2009/0297107 A1 for an Optical Fiber Telecommunication Cable, filed May 15, 2009, (Tatat); U.S. Patent Application Publication No. US2009/0279833 A1 for a Buffer Tube with Adhesively Coupled Optical Fibers and/or Water-Swellable Element, filed Jul. 21, 2009, (Overton et al.); U.S. Patent Application Publication No. US2010/0092135 A1 for an Optical Fiber Cable Assembly, filed Sep. 10, 2009, (Barker et al.); U.S. Pat. No. 7,974,507 A1 for a High-Fiber-Density Optical Fiber Cable (Louie et al.); U.S. Pat. No. 7,970,247 for a Buffer Tubes for Mid-Span Storage (Barker); U.S. Patent Application Publication No. US2010/0135623 A1 for Single-Fiber prop Cables for MDU Deployments, filed Nov. 9, 2009, (Overton); U.S. Pat. No. 8,041,167 for an Optical-Fiber Loose Tube Cables, filed Nov. 9, 2009, (Overton); U.S. Patent Application Publication No. US2010/0135624 A1 for a Reduced-Size Flat prop Cable, filed Nov. 9, 2009, (Overton et al.); U.S. Patent Application Publication No. US2010/0092138 A1 for ADSS Cables with High-Performance Optical Fiber, filed Nov. 9, 2009, (Overton); U.S. Pat. No. 8,041,168 for Reduced-Diameter Ribbon Cables with High-Performance Optical Fiber, filed Nov. 10, 2009, (Overton); U.S. Pat. No. 8,031,997 for a Reduced-Diameter, Easy-Access Loose Tube Cable, filed Nov. 10, 2009, (Overton); U.S. Patent Application Publication No. US2010/0154479 A1 for a Method and Device for Manufacturing an Optical Preform, filed Dec. 19, 2009, (Milicevic et al.); U.S. Patent Application Publication No. US 2010/0166375 for a Perforated Water-Blocking Element, filed Dec. 29, 2009, (Parris); U.S. Patent Application Publication No. US2010/0183821 A1 for a UVLED Apparatus for Curing Glass-Fiber Coatings, filed Dec. 30, 2009, (Hartsuiker et al.); U.S. Patent Application Publication No. US2010/0202741 A1 for a Central-Tube Cable with High-Conductivity Conductors Encapsulated with High-Dielectric-Strength Insulation, filed Feb. 4, 2010, (Ryan et al.); U.S. Patent Application Publication No. US2010/0215328 A1 for a Cable Having Lubricated, Extractable Elements, filed Feb. 23, 2010, (Tatat et al.); U.S. Patent Application Publication No. US2011/0026889 A1 for a Tight-Buffered Optical Fiber Unit Having Improved Accessibility, filed Jul. 26, 2010, (Risch et al.); U.S. Patent Application Publication No. US2011/0064371 A1 for Methods and Devices for Cable Insertion into Latched Conduit, filed Sep. 14, 2010, (Leatherman et al.); U.S. Patent Publication No. 2011/0069932 A1 for a High-Fiber-Density Optical-Fiber Cable, filed Oct. 19, 2010, (Overton et al.); U.S. Patent Publication No. 2011/0091171 A1 for an Optical-Fiber Cable Having High Fiber Count and High Fiber Density, filed Oct. 19, 2010, (Tatat et al.); U.S. Patent Publication No. 2011/0176782 A1 for a Water-Soluble Water-Blocking Element, filed Jan. 19, 2011, (Parris); U.S. Patent Publication No. 2011/0268400 A1 for a Data-Center Cable, filed Apr. 28, 2011, (Lovie et al.); U.S. Patent Publication No. 2011/0268398 A1 for a Bundled Fiber Optic Cables, filed May 3, 2011, (Quinn et al.); U.S. patent application Ser. No. 13/111,147 for a Curing Apparatus Employing Angled UVLEDs, filed May 19, 2011, (Molin); U.S. patent application Ser. No. 13/116,141 for a Low-Smoke and Flame-Retardant Fiber Optic Cables, filed May 26, 2011, (Lovie et al.); U.S. patent application Ser. No. 13/152,651 for a Curing Apparatus Having UV Sources That Emit Differing Ranges of UV Radiation, filed Jun. 3, 2011, (Gharbi et al.); U.S. patent application Ser. No. 13/181,762 for a Adhesively Coupled Optical Fibers and Enclosing Tape, filed Jul. 13, 2011, (Parris); U.S. patent application Ser. No. 13/206,601 for a Method and Apparatus Providing Increased UVLED Intensity, filed Aug. 10, 2011, (Overton); and U.S. patent application Ser. No. 13/222,329 for an Optical-Fiber Module Having Improved Accessibility, filed Aug. 31, 2011, (Tatat).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. An optical fiber, comprising:
a central core comprising a core matrix and nanoparticles, said core matrix surrounding said nanoparticles, wherein said nanoparticles are formed of rare-earth-dopant elements within a nanoparticle matrix; and
an optical cladding surrounding said central core, said optical cladding comprising a plurality of holes separated by a pitch Λₕₒₗₑ and extending along the length of the optical fiber.

2. The optical fiber according to claim 1, wherein:
the concentration of chlorine in said optical cladding is about 500 ppm or less; and
the total concentration of impurities in said optical cladding is 1 ppb or less.

3. The optical fiber according to claim 1, wherein:
the concentration of chlorine in said optical cladding is about 100 ppm or less; and
the total concentration of impurities in said optical cladding is 1 ppb or less.

4. The optical fiber according to claim 1, wherein said optical cladding is made of pure silica.

5. The optical fiber according to claim 1, wherein the holes and said central core have a symmetry of rotation about the center of the optical fiber only of order π.

6. The optical fiber according to claim 1, wherein the pitch Λₕₒₗₑ is between about 2 microns and 10 microns.

7. The optical fiber according to claim 1, wherein:
the holes have a substantially circular cross-section and a diameter Φₕₒₗₑ; and
the ratio Φₕₒₗₑ/Λₕₒₗₑ of the diameter Φₕₒₗₑ to the pitch Λₕₒₗₑ is between about 0.3 and 0.9.

8. The optical fiber according to claim 1, wherein said core matrix is made of pure silica.

9. The optical fiber according to claim 1, wherein, within said central core:
the concentration of rare-earth-dopant elements is between about 200 ppm and 1000 ppm; and
the concentration of said nanoparticle matrix is between about 0.5 weight percent and 5 weight percent.

10. The optical fiber according to claim 1, wherein, within said nanoparticles, the atomic ratio of said nanoparticle matrix to said rare-earth-dopant elements is between about 10 and 500.

11. The optical fiber according to claim 1, wherein, within said nanoparticles, the atomic ratio of said nanoparticle matrix to said rare-earth-dopant elements is between about 50 and 350.

12. The optical fiber according to claim 1, wherein said nanoparticle matrix is alumina and/or silica.

13. The optical fiber according to claim 1, wherein said rare-earth-dopant elements are erbium, ytterbium, and/or thulium.

14. An optical amplifier including the optical fiber according to claim 1, wherein said optical amplifier provides amplification at a pump power of between about 150 mW and 1500 mW.

15. The optical amplifier according to claim 14, wherein the optical amplifier has a bandwidth in the range 25 nanometers to 32 nanometers in the C band.

16. An optical fiber laser including the optical fiber according to claim 1.

17. A method of making a primary optical preform, comprising:
forming a preform core that includes nanoparticles containing rare-earth-dopant elements, said preform core contributing to forming the central core of the optical fiber;
fabricating a plurality of capillaries; and
arranging the capillaries around the preform core to form a bundle with the preform core at its center.

18. The method according to claim 17, wherein the preform core is formed of a material based on pure silica.

19. The method according to claim 17, wherein (i) the concentration of chlorine in the capillaries is about 500 ppm or less, and (ii) the total concentration of impurities in the capillaries is 1 ppb or less.

20. The method according to claim 17, wherein (i) the concentration of chlorine in the capillaries is about 100 ppm or less, and (ii) the total concentration of impurities in the capillaries is 1 ppb or less.

21. The method according to claim 17, wherein the capillaries are pure silica.

22. The method according to claim 17, wherein the step of forming a preform core comprises:
depositing a tubular, porous deposit on the interior surface of a tube;
impregnating the porous deposit with a suspension of nanoparticles that contain rare-earth-dopant elements;
vitrifying the impregnated porous deposit;
collapsing the tube and the vitrified, impregnated porous deposit; and
extracting the vitrified, impregnated porous deposit from the tube.

23. The method according to claim 22, wherein the step of depositing a porous deposit is performed via a modified chemical vapor deposition (MCVD) technique.

24. The method according to claim 17, wherein the step of forming a preform core comprises:
forming a rod comprising nanoparticles that contain rare-earth-dopant elements;
vitrifying the rod; and
collapsing the vitrified rod.

25. The method according to claim 24, wherein the rod is formed via a sol-gel process.

26. The method according to claim 17, wherein the step of fabricating a plurality of capillaries comprises:
depositing a tubular deposit on the inside surface of a tube;
extracting the tubular deposit; and
drawing one or more capillaries from the tubular deposit.

27. The method according to claim 26, wherein the step of depositing a tubular deposit is carried out via a plasma chemical vapor deposition (PCVD) technique.

28. The method according to claim 17, wherein the step of fabricating a plurality of capillaries comprises:
depositing a tubular deposit on the inside surface of a tube; and
drawing one or more capillaries from the tube having the tubular deposit on its inside surface.

29. The method according to claim 28, wherein the step of depositing a tubular deposit is carried out via a plasma chemical vapor deposition (PCVD) technique.

30. The method according to claim 17, wherein the step of forming a preform core comprises forming a preform core having a concentration of nanoparticles of between about 10¹⁶/cm³ and 10¹⁸/cm³.

31. The method according to claim 17, wherein the step of forming a preform core comprises forming a preform core including substantially spherical nanoparticles having a diameter of between about 5 nanometers and 25 nanometers.
